(19) United States
(12) Patent Application Publication
(10) Pub. No.: US 2019/0233317 A1
(43) Pub. Date: Aug. 1, 2019

(54) MANUFACTURING APPARATUS FOR OPTICAL ELEMENT AND MANUFACTURING METHOD FOR OPTICAL ELEMENT

(71) Applicant: OLYMPUS CORPORATION, Tokyo (JP)

(72) Inventor: Motosuke MISAKA, Tokyo (JP)

(73) Assignee: OLYMPUS CORPORATION, Tokyo (JP)

(21) Appl. No.: 16/378,864

(22) Filed: Apr. 9, 2019

Related U.S. Application Data
(63) Continuation of application No. PCT/JP2017/039353, filed on Oct. 31, 2017.

(30) Foreign Application Priority Data
Oct. 31, 2016 (JP) 2016-213453

(51) Int. Cl. C03B 11/08; C03B 11/16

(52) U.S. Cl. CPC C03B 11/08; C03B 11/16

(57) ABSTRACT

A manufacturing apparatus for manufacturing an optical element including two spherical segments and a cylindrical portion by performing press molding using a mold on a molding material that is softened by heat includes: a sensor configured to measure one of a diameter and mass of the molding material; a calculator configured to calculate a target thickness of the optical element based on one of the diameter and the mass of the molding material measured by the sensor; and a controller configured to control an inter-mold distance of the mold at a time of press molding such that a thickness of the optical element becomes the target thickness calculated by the calculator unit.

### CROSS-REFERENCE TO RELATED APPLICATION

This application is a continuation of PCT International Application No. PCT/JP2017/039353 filed on Oct. 31, 2017, which designates the United States, incorporated herein by reference, and which claims the benefit of priority from Japanese Patent Application No. 2016-213453, filed on Oct. 31, 2016, incorporated herein by reference.

### BACKGROUND

The present disclosure relates to a manufacturing apparatus for optical element and a manufacturing method for optical element.

As described in Japanese Patent No. 3220512 for example, a manufacturing apparatus for optical element that causes a detecting unit to detect a position of a mold during molding when performing press molding on a molding material (preform) that is softened by heat, to thereby improve accuracy in controlling a thickness of an optical element has been proposed.

### SUMMARY

According to one aspect of the present disclosure, there is provided a manufacturing apparatus for manufacturing an optical element including two spherical segments and a cylindrical portion by performing press molding using a mold on a molding material that is softened by heat, the manufacturing apparatus including: a sensor configured to measure one of a diameter and mass of the molding material; a calculator configured to calculate a target thickness of the optical element based on one of the diameter and the mass of the molding material measured by the sensor; and a controller configured to control an inter-mold distance of the mold at a time of press molding such that a thickness of the optical element becomes the target thickness calculated by the calculator unit.

The above and other features, advantages and technical and industrial significance of this disclosure will be better understood by reading the following detailed description of presently preferred embodiments of the disclosure, when considered in connection with the accompanying drawings.

### BRIEF DESCRIPTION OF THE DRAWINGS

FIG. 1 is a diagram illustrating a configuration of a manufacturing apparatus for optical element according to a first embodiment;

FIG. 2 is a diagram for explaining symbols used in calculation formulas for calculating a thickness of an optical element in the manufacturing apparatus for optical element according to the first embodiment;

FIG. 3 is a flowchart illustrating a manufacturing method for optical element according to the first embodiment;

FIG. 4A and FIG. 4B are diagrams for explaining an amount of pressing a mold in the manufacturing apparatus for optical element according to the first embodiment;

FIG. 5 is a diagram for explaining a relationship among a volume of a molding material, the thickness of the optical element, and an outer diameter of the optical element in the manufacturing apparatus for optical element according to the first embodiment;

FIG. 6 is a diagram illustrating a configuration of main parts of a manufacturing apparatus for optical element according to a third embodiment;

FIG. 7 is a diagram illustrating a configuration of main parts of a manufacturing apparatus for optical element according to a fourth embodiment;

FIG. 8 is a diagram illustrating a configuration of main parts of a manufacturing apparatus for optical element according to a fifth embodiment; and

FIG. 9 is a diagram illustrating a configuration of main parts of a manufacturing apparatus for optical element according to a sixth embodiment.

### DETAILED DESCRIPTION

Exemplary embodiments of a manufacturing apparatus for optical element according to the present disclosure will be described below with reference to the drawings. The present disclosure is not limited by the embodiments below, and configuration elements in the embodiments described below include elements easily replaceable by a person skilled in the art and elements substantially the same.

### First Embodiment

### Manufacturing Apparatus for Optical Element

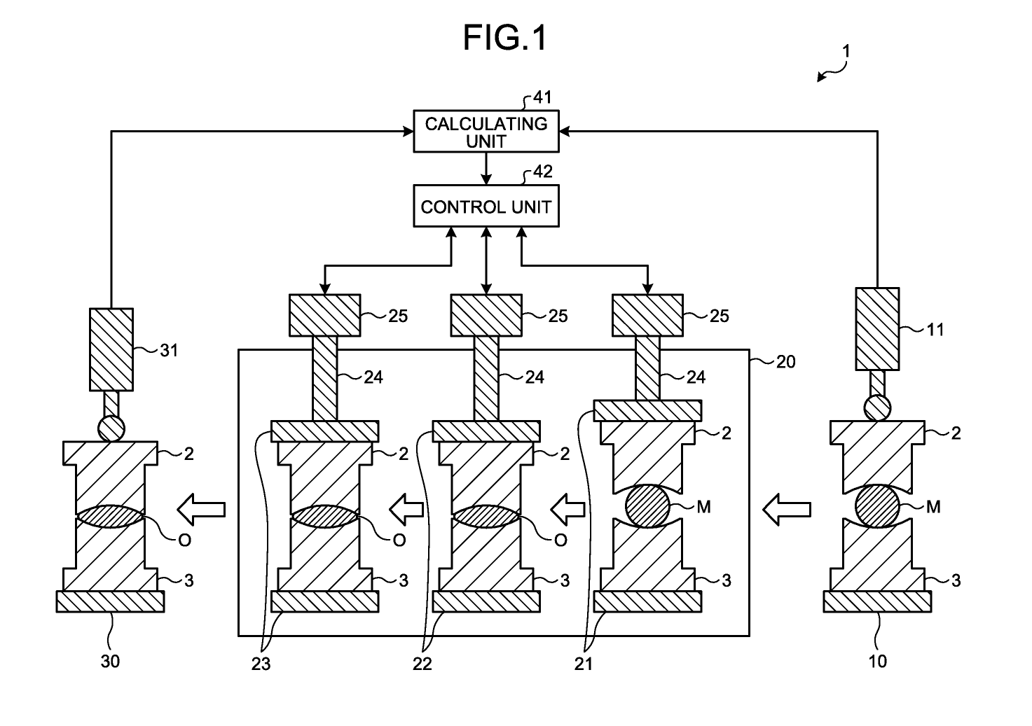

A configuration of a manufacturing apparatus for optical element according to a first embodiment will be described with reference to FIG. 1.

The manufacturing apparatus for optical element is an apparatus that manufactures an optical element, such as a glass lens, by performing press molding using a mold on a molding material that is softened by heat. A manufacturing apparatus 1 for an optical element O (hereinafter, simply referred to as the “manufacturing apparatus 1”) includes, as illustrated in FIG. 1, a mold including an upper mold 2 and a lower mold 3, a wait stage 10, an inlet measuring unit 11, a molding room 20, and an ejection stage 30. The manufacturing apparatus 1 may further include an outlet measuring unit 31 in addition to the components as described above.

The upper mold 2 and the lower mold 3 are formed in convex shapes, and arranged such that respective molding surfaces face each other. In FIG. 1, only components needed for explaining the embodiments are illustrated, and some components, such as a sleeve for holding the upper mold 2 and the lower mold 3, are omitted.

On the wait stage 10, a spherical molding material M is arranged between the upper mold 2 and the lower mold 3. The inlet measuring unit (measuring sensor) 11 is constructed with a sensor such as, for example, a Magnescale, and measures a diameter of the molding material M that is held by the upper mold 2 and the lower mold 3 on the wait stage 10. Specifically, the inlet measuring unit 11 measures the entire thickness of the upper mold 2 and the lower mold 3 between which the molding material M is arranged, determines the diameter of the molding material M by subtracting thicknesses of the upper mold 2 and the lower mold 3, which are measured in advance, from the entire thickness, and outputs the diameter to a calculating unit (calculator) 41.

The molding room 20 includes a heating stage 21, a pressing stage 22, and a cooling stage 23. Each of the stages is constructed as a pair of an upper part and a lower part, and a shaft 24 is attached to the upper part. The shaft 24 is configured so as to be moved up and down by a pressurizing position determining unit 25. Further, each of the stages includes a heater (not illustrated), and is able to control temperatures of the upper mold 2 and the lower mold 3 as desired.

The heating stage 21 heats the upper mold 2 and the lower mold 3, to thereby soften the molding material M. Further, the pressing stage 22 presses the molding material M by the upper mold 2 and the lower mold 3, to thereby mold the optical element O. Furthermore, the cooling stage 23 cools the upper mold 2 and the lower mold 3, to thereby harden the molded optical element O.

At the ejection stage 30, the upper mold 2 and the lower mold 3 are collected. Meanwhile, the manufacturing apparatus 1 includes a conveying arm (not illustrated), and the conveying arm conveys the upper mold 2 and the lower mold 3 among the wait stage 10, the heating stage 21, the pressing stage 22, the cooling stage 23, and the ejection stage 30, and collects the upper mold 2 and the lower mold 3 at the ejection stage 30.

The outlet measuring unit 31 is constructed with a sensor such as, for example, a Magnescale, similarly to the inlet measuring unit 11, and measures the thickness of the optical element O that is held by the upper mold 2 and the lower mold 3 on the ejection stage 30. Specifically, the outlet measuring unit 31 measures the entire thickness of the upper mold 2 and the lower mold 3 between which the molding material M is arranged, determines the thickness of the optical element O by subtracting the thicknesses of the upper mold 2 and the lower mold 3, which are measured in advance, from the entire thickness, and outputs the determined thickness to the calculating unit 41.

The calculating unit 41 calculates a target thickness of the molded optical element O based on the diameter of the molding material M or the like. The calculating unit 41 first calculates a volume of the molding material M based on the diameter of the molding material M measured by the inlet measuring unit 11. Subsequently, the calculating unit 41 calculates heights of spherical segments and a cylindrical portion of the optical element O based on the calculated volume of the molding material M, a target outer diameter of the optical element O set in advance, and curvatures of the spherical segments of the optical element O set in advance. Then, the calculating unit 41 calculates the target thickness of the optical element O based on the calculated heights of the spherical segments and the cylindrical portion of the optical element. A method of calculating the volume of the molding material M and the target thickness of the optical element O by the calculating unit 41 will be described in detail later.

A control unit (controller or processor) 42 controls an inter-mold distance between the upper mold 2 and the lower mold 3 based on the target thickness of the optical element O. In other words, the control unit 42 controls a position of the pressurizing position determining unit 25, to thereby control the inter-mold distance between the upper mold 2 and the lower mold 3 at the time of press molding such that the target thickness of the optical element O calculated by the calculating unit 41 is obtained. A method of controlling the inter-mold distance by the control unit 42 will be described in detail later.

### Manufacturing Method for Optical Element

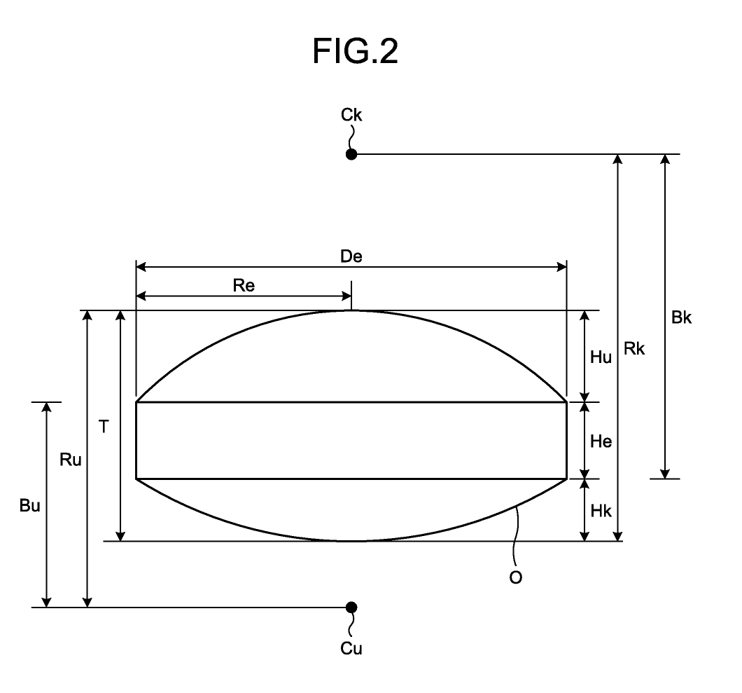

A manufacturing method for the optical element O using the manufacturing apparatus 1 will be described below with reference to FIG. 2 to FIG. 4B.

The manufacturing apparatus 1 manufactures the optical element O formed of two spherical segments and a cylindrical portion as illustrated in FIG. 2. In the following description, as illustrated in FIG. 2, the target outer diameter of the optical element O is denoted by De, a radius of the optical element O is denoted by Re, the target thickness of the optical element O is denoted by T, a height of the upper spherical segment is denoted by Hu, a height of the lower spherical segment is denoted by Hk, a height of the cylindrical portion is denoted by He, a curvature of the upper spherical segment is denoted by Ru, a center of the curvature of the upper spherical segment is denoted by Cu, a distance from an upper edge of the cylindrical portion (a lower edge of the upper spherical segment) to the center Cu of the curvature of the upper spherical segment is denoted by Bu, a curvature of the lower spherical segment is denoted by Rk, a center of the curvature of the lower spherical segment is denoted by Ck, and a distance from a lower edge of the cylindrical portion (an upper edge of the lower spherical segment) to the center Ck of the curvature of the lower spherical segment is denoted by Bk. Furthermore, in the following description, a volume of the upper spherical segment of the optical element O is denoted by Vu, a volume of the lower spherical segment is denoted by Vk, a volume of the cylindrical portion is denoted by Ve, the diameter of the molding material M is denoted by Ds, a radius of the molding material M is denoted by Rs, and the volume of the molding material M is denoted by Vs.

First, the inlet measuring unit 11 of the manufacturing apparatus 1 measures the diameter Ds of the molding material M (Step S1). Subsequently, the calculating unit 41 of the manufacturing apparatus 1 calculates the volume Vs of the molding material M (Step S2).

At Step S2, the calculating unit 41 calculates the radius Rs of the molding material M by Equation (1) below, and thereafter calculates the volume Vs of the molding material M by Equation (2) below.

Rs=Ds/2 (1)

Vs=4/3×π×Rs³ (2)

Subsequently, the calculating unit 41 of the manufacturing apparatus 1 calculates the target thickness T of the optical element O (Step S3). A method of calculating the target thickness T of the optical element O at Step S3 is described in detail below.

First, the calculating unit 41 calculates the heights of the spherical segments of the optical element O based on the target outer diameter De of the optical element O and the curvatures of the spherical segments of the optical element O. Here, the “spherical segments” indicate the upper spherical segment and the lower spherical segment of the optical element O, the “curvatures of the spherical segments” indicate the curvature Ru of the upper spherical segment and the curvature Rk of the lower spherical segment in the optical element O, and the “heights of the spherical segments” indicate the height Hu of the upper spherical segment and the height Hk of the lower spherical segment in the optical element O. Meanwhile, the target outer diameter De of the optical element O, the curvature Ru of the upper spherical segment, and the curvature Rk of the lower spherical segment are values that are set in advance and are known values.

Specifically, the calculating unit 41 calculates the radius Re of the optical element O by Equation (3) below, and thereafter calculates the height Hu of the upper spherical segment and the height Hk of the lower spherical segment in the optical element O by Equation (4) and Equation (5) below.

Re=De/2 (3)

Hu=Ru−Bu=Ru−√(Ru²−Re²) (4)

Hk=Rk−Bk=Rk−√(Rk²−Re²) (5)

Subsequently, the calculating unit 41 calculates the volumes of the spherical segments of the optical element O based on the heights of the spherical segments of the optical element O and the curvatures of the spherical segments of the optical element O. Here, the “volumes of the spherical segments” indicate the volume Vu of the upper spherical segment and the volume Vk of the lower spherical segment in the optical element O.

Specifically, the calculating unit 41 calculates the volume Vu of the upper spherical segment and the volume Vk of the lower spherical segment in the optical element O by

Equation (6) and Equation (7) below.

Vu=π/6×Hu×(3×Ru²+Hu²) (6)

Vk=π/6×Hk×(3×Rk²+Hk²) (7)

Subsequently, the calculating unit 41 calculates the volume Ve of the cylindrical portion of the optical element O by subtracting the volumes of the spherical segments (the volume Vu of the upper spherical segment and the volume Vk of the lower spherical segment) of the optical element O from the volume Vs of the molding material M.

Here, a relationship among the volume Vs of the molding material M, the volume Vu of the upper spherical segment of the optical element O, the volume Vk of the lower spherical segment of the optical element O, and the volume Ve of the cylindrical portion of the optical element O is represented by Equation (8) below. Therefore, the calculating unit 41 calculates the volume Ve of the cylindrical portion of the optical element O by Equation (9) below.

Vs=Vu+Vk+Ve (8)

Ve=Vs−Vu−Vk (9)

Subsequently, the calculating unit 41 calculates the height He of the cylindrical portion of the optical element O based on the volume Ve of the cylindrical portion of the optical element O and the target outer diameter De of the optical element O.

Here, a relationship among the volume Ve of the cylindrical portion of the optical element O, the radius Re of the optical element O, and the height He of the cylindrical portion of the optical element O is indicated by Equation (10) below. Therefore, the calculating unit 41 calculates the radius Re of the optical element O by Equation (3) above, and thereafter calculates the height He of the cylindrical portion of the optical element O by Equation (11) below.

Ve=π×Re²×He (10)

He=Ve/(π×Re²) (11)

Lastly, as indicated by Equation (12) below, the calculating unit 41 calculates the target thickness T of the optical element O by adding the heights of the spherical segments (the height Hu of the upper spherical segment and the height Hk of the lower spherical segment) of the optical element O and the height He of the cylindrical portion of the optical element O.

T=Hu+Hk+He (12)

Subsequently, the control unit 42 of the manufacturing apparatus 1 controls the inter-mold distance between the upper mold 2 and the lower mold 3 (Step S4). Specifically, the control unit 42 outputs, to the pressurizing position determining unit 25, the coordinates of a height position of the upper mold 2 such that the target thickness T of the molded optical element O is obtained. The pressurizing position determining unit 25 adjusts the inter-mold distance between the upper mold 2 and the lower mold 3 by moving the upper mold 2 relative to the lower mold 3 based on the coordinates.

Meanwhile, the pressurizing position determining unit 25 includes a built-in scale (not illustrated) for measuring the height position of the upper mold 2, and continuously sending the coordinates of the height position of the upper mold 2 based on the built-in scale to the control unit 42 during molding. Accordingly, when the upper mold 2 approaches the coordinates of the target height position, the control unit 42 causes the pressurizing position determining unit 25 to reduce pressure or speed such that the upper mold 2 is eventually stopped at the target height position.

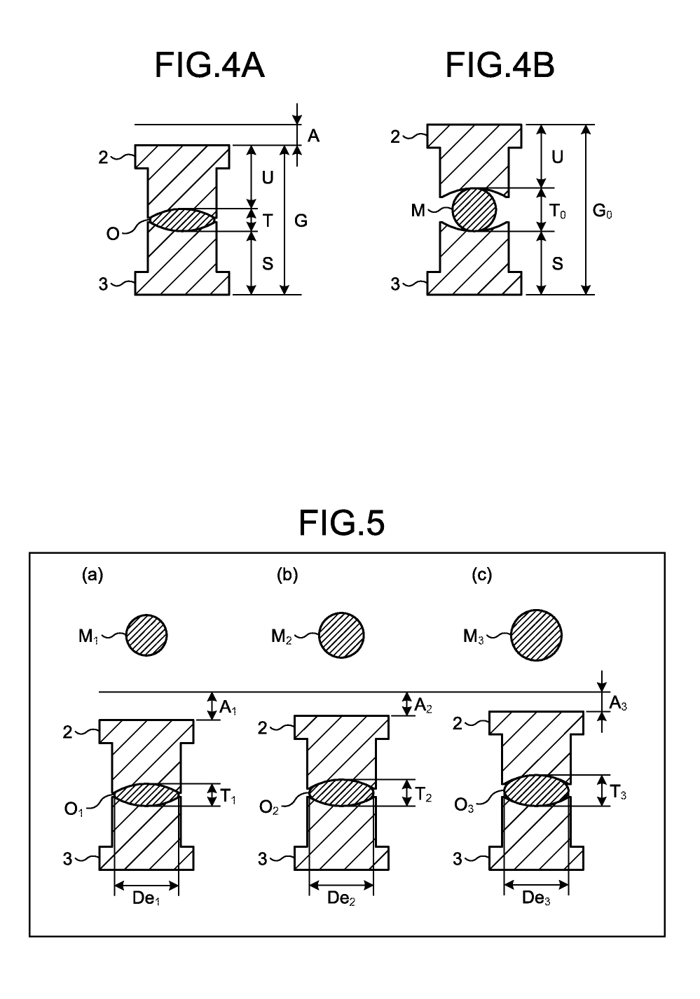

Here, as illustrated in FIG. 4A, assuming that the thickness of the upper mold 2 is denoted by U, the thickness of the lower mold 3 is denoted by S, and the target thickness of the optical element O obtained after molding is denoted by T, a thickness G of the mold obtained after the upper mold 2 is pressed is represented by Equation (13) below. Further, as illustrated in FIG. 4B, assuming that the thickness (diameter) of the molding material M obtained before molding is denoted by T₀, a thickness G₀ of the mold obtained before the upper mold 2 is pressed is represented by Equation (14) below. Therefore, a pressing amount A of the upper mold 2 is represented by Equation (15) below.

G=U+S+T (13)

G₀=U+S+T₀ (14)

A=G₀−G (15)

Here, if the manufacturing apparatus 1 further includes the outlet measuring unit 31, it may be possible to perform a process of correcting the target thickness T of the optical element O after Step S4 described above. In other words, in some cases, the target thickness T calculated by Equation (12) described above may be deviated from an actual thickness depending on dimensional tolerance of the molds (the upper mold 2 and the lower mold 3) or the accuracy of the inlet measuring unit 11. In this case, the process of correcting the target thickness T is performed by sending, as feedback, the thickness of the optical element O obtained after molding to the calculating unit 41.

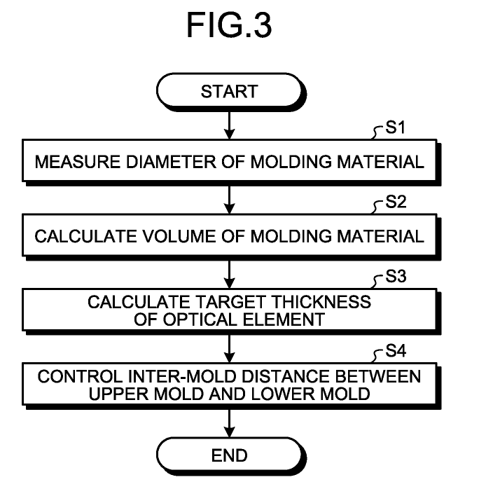

Specifically, the outlet measuring unit 31 measures the thickness of the optical element O held by the upper mold 2 and the lower mold 3 on the ejection stage 30, and outputs the thickness to the calculating unit 41. Subsequently, the calculating unit 41 calculates an amount of deviation between the thickness measured by the outlet measuring unit 31 and the target thickness T calculated at Step S3 in the current process (see FIG. 3). Then, the calculating unit 41 adds the amount of deviation, as a correction amount, to the target thickness T that is calculated by Equation (12) at Step S3 in next and later molding processing, to thereby correct the target thickness T.

Here, the process of correcting the target thickness T as described above is performed for each mold and each molding condition. In other words, the amount of deviation of the thickness is calculated only once for the same mold and the same molding condition, and when molding is performed using the same mold and the same condition, the same amount of deviation is always added as the correction amount to the calculated target thickness T at Step S4 (see FIG. 3). The manufacturing apparatus 1 is able to manufacture the optical element O having an accurate thickness and stabilize the outer diameter of the optical element O by performing the process of correcting the target thickness T as described above.

Meanwhile, an amount of variation of the outer diameter of the optical element O caused by the deviation between the target thickness T and the actual thickness as described above is extremely small as compared to an amount of variation of the outer diameter of the optical element O caused by variation among the volumes of the molding materials M, and does not have a large influence on optical performance or the like.

According to the manufacturing apparatus 1 as described above, the thickness of the optical element O in press molding is controlled depending on the volume of the molding material M, so that even when the volumes of the molding materials M vary, it is possible to control variation in the outer diameter of the optical element O and manufacture the optical element O with a constant outer diameter.

For example, as illustrated in (a), (b), and (c) of FIG. 5, a case will be described in which three molding materials M₁, M₂, and M₃ with a volume relationship of M₁<M₂<M₃ are molded by the manufacturing apparatus 1. In this case, the pressing amount of the upper mold 2 is reduced in order of the molding materials M₁, M₂, and M₃ (pressing amounts are A₁>A₂>A₃), and thicknesses of the optical elements O₁, O₂, and O₃ obtained after molding are increased in order of the molding materials M₁, M₂, and M₃ (thicknesses are T₁<T₂<T₃). However, as illustrated in FIG. 5, outer diameters of the optical elements O₁, O₂, and O₃ obtained after molding are maintained constant regardless of variation among the volumes of the molding materials M₁, M₂, and M₃ (outer diameters are De₁=De₂=De₃).

Further, in the manufacturing apparatus 1, it is not necessary to separately perform a coring process for processing an optical core and an outer diameter, so that it is possible to reduce manufacturing man-hours and manufacturing cost as compared to a manufacturing method in which the coring process is needed.

### Second Embodiment

In the first embodiment as described above, the inlet measuring unit 11 measures the diameter of the molding material M at the time of molding the molding material M. However, the inlet measuring unit 11 may measure mass (weight) of the molding material M.

Specifically, in a manufacturing apparatus according to a second embodiment, the inlet measuring unit 11 measures mass Ws of the molding material M held by the upper mold 2 and the lower mold 3 on the wait stage 10, and outputs the mass to the calculating unit 41 each time. Subsequently, the calculating unit 41 calculates the volume Vs of the molding material M by Equation (16) below based on the mass Ws of the molding material M measured by the inlet measuring unit 11 and density (specific gravity) ps of the molding material M.

Vs=Ws×ρs (16)

Subsequently, the calculating unit 41 calculates the target thickness T of the optical element O using the same method as in the first embodiment described above (see Step S3 in FIG. 3). Then, the control unit 42 controls the inter-mold distance between the upper mold 2 and the lower mold 3 using the same method as in the first embodiment described above (see Step S4 in FIG. 3).

According to the manufacturing apparatus of the second embodiment as described above, similarly to the manufacturing apparatus 1 according to the first embodiment as described above, even when the volumes of the molding materials M vary, it is possible to manufacture the optical element O with a constant outer diameter. Further, the manufacturing apparatus according to the second embodiment is able to calculate the volume of the molding material M with high accuracy even when the molding material M does not have a spherical shape, so that it is possible to calculate the target thickness T of the optical element O with accuracy.

### Third Embodiment

In the first embodiment as described above, the inlet measuring unit 11 measures the diameter Ds of the molding material M held by the upper mold 2 and the lower mold 3 on the wait stage 10 at the time of molding the molding material M, and outputs the diameter Ds to the calculating unit 41 each time. However, it may be possible to cause an external apparatus to measure the diameter Ds of the molding material M and output the diameter Ds to the calculating unit 41 in advance, instead of providing the inlet measuring unit 11.

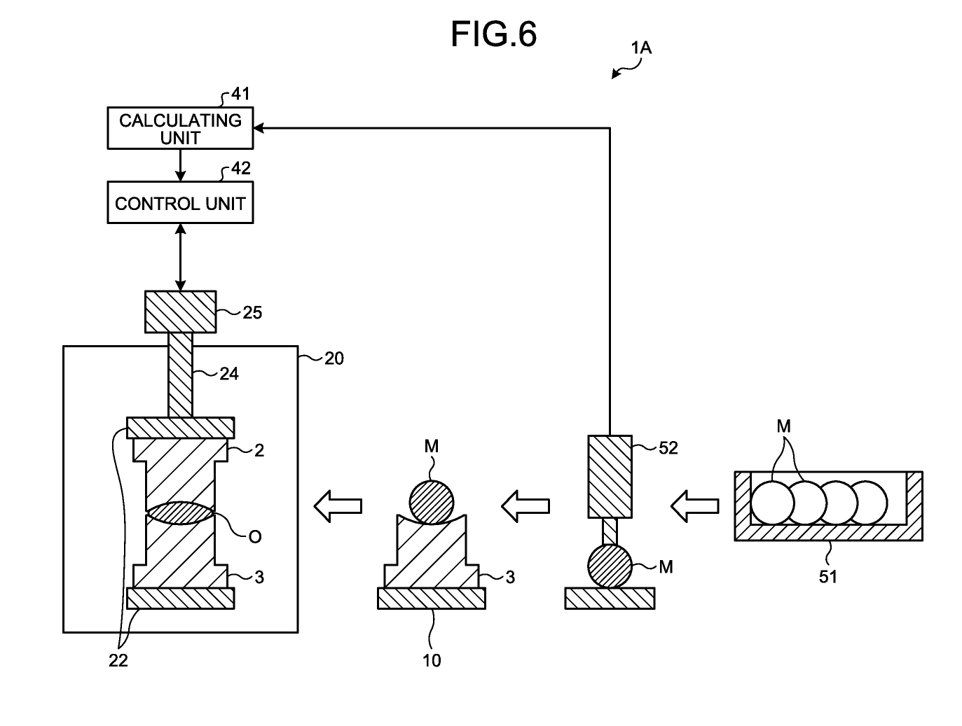

Specifically, as illustrated in FIG. 6, in a manufacturing apparatus 1A according to a third embodiment, the molding material M stored in a material stock container 51 is moved to a diameter measuring unit (measuring sensor) 52 one by one by a conveying arm (not illustrated). Subsequently, the diameter measuring unit 52 measures the diameter Ds of the molding material M and outputs the diameter Ds to the calculating unit 41. Then, the calculating unit 41 calculates the volume Vs of the molding material M based on the diameter Ds of the molding material M measured by the diameter measuring unit 52 and thereafter calculates the target thickness T of the optical element O using the same method as in the first embodiment described above (see Steps S2 and S3 in FIG. 3). Then, the control unit 42 controls the inter-mold distance between the upper mold 2 and the lower mold 3 using the same method as in the first embodiment described above (see Step S4 in FIG. 3).

According to the manufacturing apparatus 1A of the third embodiment as described above, similarly to the manufacturing apparatus 1 according to the first embodiment as described above, even when the volumes of the molding materials M vary, it is possible to manufacture the optical element O with a constant outer diameter. Further, the manufacturing apparatus 1A is able to measure the diameter Ds of the molding material M with stability and accuracy before arranging the molding material M on the wait stage 10, so that it is possible to calculate the target thickness T of the optical element O with high accuracy.

### Fourth Embodiment

In the second embodiment as described above, the inlet measuring unit 11 measures the mass Ws of the molding material M held by the upper mold 2 and the lower mold 3 on the wait stage 10 at the time of molding the molding material M, and outputs the mass Ws to the calculating unit 41 each time. However, it may be possible to cause an external apparatus to measure the mass Ws of the molding material M and output the mass Ws to the calculating unit 41 in advance, instead of providing the inlet measuring unit 11.

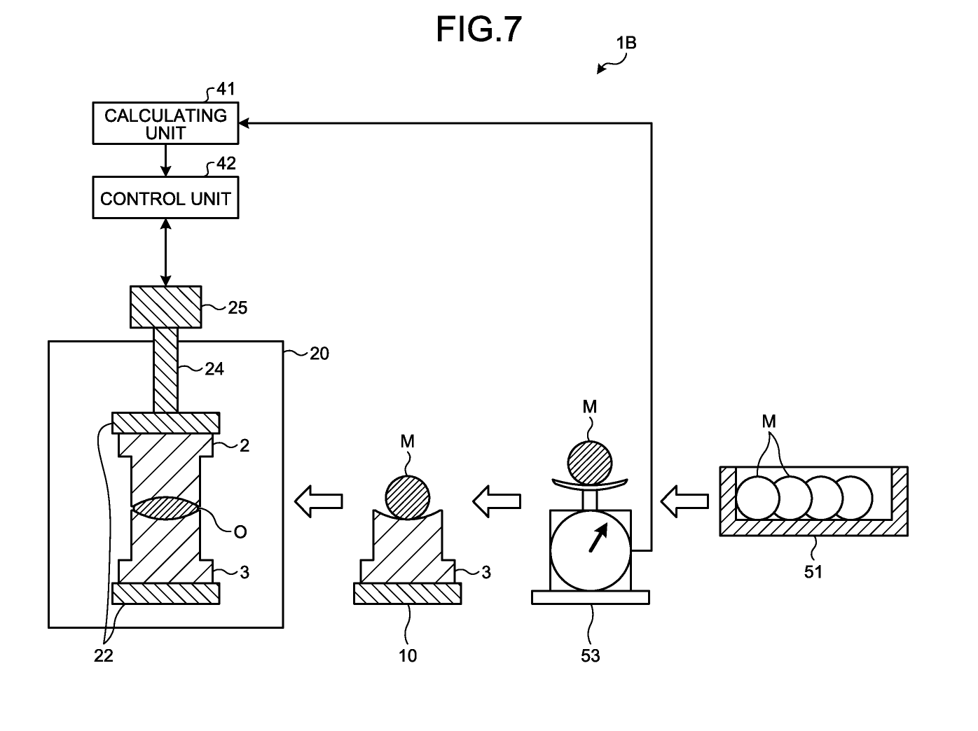

Specifically, as illustrated in FIG. 7, in a manufacturing apparatus 1B according to a fourth embodiment, the molding material M stored in the material stock container 51 is moved to a mass measuring unit (measuring sensor) 53 one by one by a conveying arm (not illustrated). Subsequently, the mass measuring unit 53 measures the mass Ws of the molding material M and outputs the mass Ws to the calculating unit 41. Then, the calculating unit 41 calculates the volume Vs of the molding material M based on the mass Ws of the molding material M measured by the mass measuring unit 53 using the same method as in the second embodiment described above, and thereafter calculates the target thickness T of the optical element O using the same method as in the first embodiment described above (see Step S3 in FIG. 3). Then, the control unit 42 controls the inter-mold distance between the upper mold 2 and the lower mold 3 using the same method as in the first embodiment described above (see Step S4 in FIG. 3).

According to the manufacturing apparatus 1B of the fourth embodiment as described above, similarly to the manufacturing apparatus 1 according to the first embodiment as described above, even when the volumes of the molding materials M vary, it is possible to manufacture the optical element O with a constant outer diameter. Further, the manufacturing apparatus 1B is able to measure the mass Ws of the molding material M with stability and accuracy before arranging the molding material M on the wait stage 10, so that it is possible to calculate the target thickness T of the optical element O with high accuracy.

### Fifth Embodiment

In the first embodiment as described above, the thickness of the optical element O held by the upper mold 2 and the lower mold 3 on the ejection stage 30 is measured after the optical element O is molded, and the thickness is output to the calculating unit 41. However, it may be possible to cause an external apparatus to measure the thickness of the optical element O and output the thickness to the calculating unit 41, instead of providing the outlet measuring unit 31.

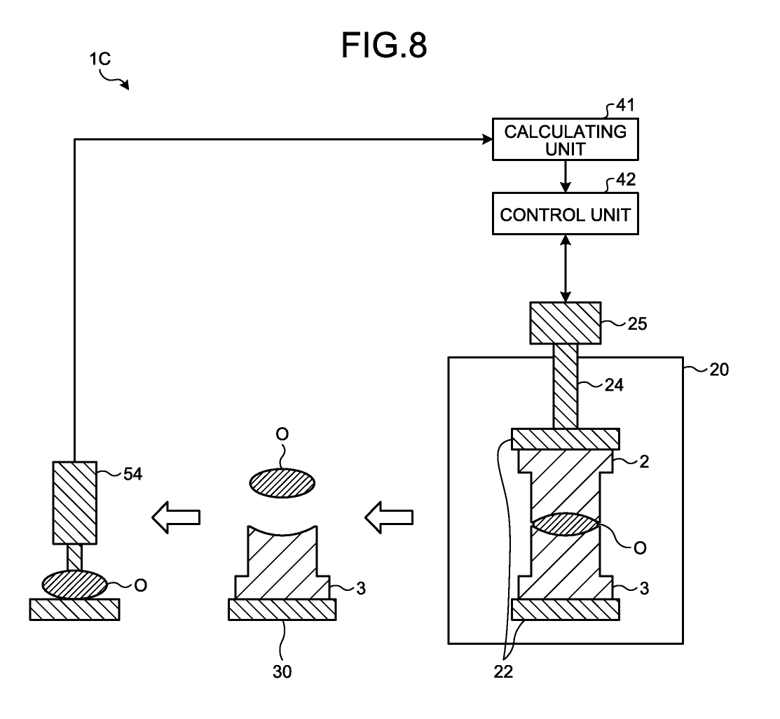

Specifically, as illustrated in FIG. 8, in a manufacturing apparatus 10 according to a fifth embodiment, the molded optical element O is moved to a thickness measuring unit (sensor) 54 by a conveying arm (not illustrated). Subsequently, the thickness measuring unit 54 measures the thickness of the molding material M and outputs the thickness to the calculating unit 41. Then, the calculating unit 41 calculates an amount of deviation between the thickness measured by the thickness measuring unit 54 and the target thickness T calculated at Step S3 as described above (see FIG. 3). Subsequently, the calculating unit 41 adds the amount of deviation, as a correction amount, to the target thickness T that is calculated by Equation (12) at Step S3 in next and later molding processing, to thereby correct the target thickness T. Meanwhile, the process of correcting the target thickness T as described above is performed for each mold and each molding condition.

According to the manufacturing apparatus 10 of the fifth embodiment as described above, similarly to the manufacturing apparatus 1 according to the first embodiment as described above, it is possible to manufacture the optical element O having an accurate thickness and stabilize the outer diameter of the optical element O. Further, the manufacturing apparatus 10 is able to measure the thickness of the optical element O with stability and accuracy in such a state that the optical element O is detached from the mold, so that it is possible to calculate the target thickness T of the optical element O with high accuracy.

### Sixth Embodiment

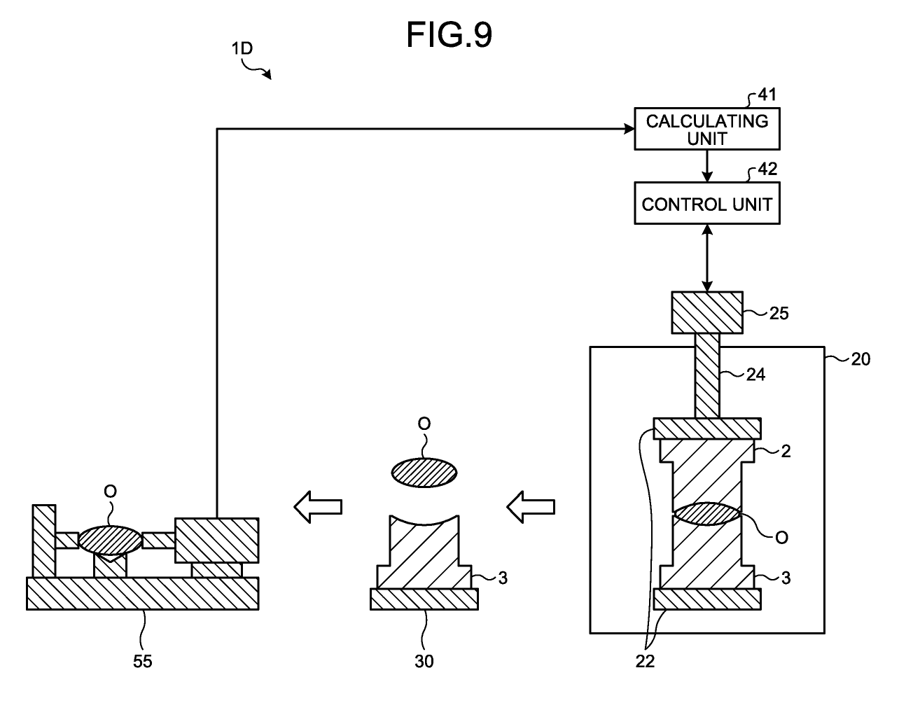

A manufacturing apparatus 1D according to a sixth embodiment further includes, as illustrated in FIG. 9, an outer diameter measuring unit (sensor) 55 that measures the outer diameter of the optical element O.

Specifically, as illustrated in FIG. 9, in the manufacturing apparatus 1D according to the sixth embodiment, the molded optical element O is moved to the outer diameter measuring unit 55 by a conveying arm (not illustrated). Subsequently, the outer diameter measuring unit 55 measures the outer diameter of the optical element O and outputs the outer diameter to the calculating unit 41. Then, the calculating unit 41 compares the outer diameter measured by the outer diameter measuring unit 55 and the target outer diameter De of the optical element O set in advance.

If the outer diameter measured by the outer diameter measuring unit 55 is larger than the target outer diameter De, the calculating unit 41 determines that the thickness of the molded optical element O is small, and calculates a corrected target thickness Th by adding a correction amount Tα to the target thickness T as represented by Equation (17) below. Further, if the outer diameter measured by the outer diameter measuring unit 55 is smaller than the target outer diameter De, the calculating unit 41 determines that the thickness of the molded optical element O is large, and calculates the corrected target thickness Th by subtracting the correction amount Tα from the target thickness T as represented by Equation (18) below.

Th=T+Tα (17)

Th=T−Tα (18)

Then, by repeating the correction as described above, the outer diameter of the molded optical element O is adjusted to the target outer diameter De. Meanwhile, the correction amount Tα as described above can be experimentally obtained in advance.

According to the manufacturing apparatus 1D of the sixth embodiment as described above, similarly to the manufacturing apparatus 1 according to the first embodiment as described above, it is possible to manufacture the optical element O having an accurate thickness and stabilize the outer diameter of the optical element O. Further, even when deviation occurs between the target outer diameter De and the actual outer diameter of the optical element O, the manufacturing apparatus 1D is able to appropriately correct the deviation.

### Seventh Embodiment

In the first to the fourth embodiments as described above, the calculating unit 41 obtains the target thickness T of the optical element O by Equations (1) to (12) based on the diameter Ds or the mass Ws of the molding material M. However, it may be possible to form, in advance, a relational expression between the diameter Ds or the mass Ws of the molding material M obtained before molding and the thickness of the optical element obtained after molding, and calculate the target thickness T of the optical element O from the diameter Ds or the mass Ws of the molding material M using the relational expression.

Specifically, when the inlet measuring unit 11 or the diameter measuring unit 52 measures the diameter Ds of the molding material M, the calculating unit 41 of a manufacturing apparatus according to a seventh embodiment calculates the target thickness T by Equation (19) below. Further, when the inlet measuring unit 11 or the mass measuring unit 53 measures the mass Ws of the molding material M, the calculating unit 41 calculates the target thickness T by Equation (20) below.

T=Ks×Ds (19)

T=Ps×Ws (20)

Here, Ks in Equation (19) above and Ps in Equation (20) above are coefficients. The coefficients Ks and Ps can be obtained by, for example, experimentally performing molding using an actual mold, measuring a change of the thickness of the optical element O with respect to the diameter Ds or the mass Ws of the molding material M while maintaining the outer diameter of the optical element O constant, and plotting a measurement result on a graph or the like.

According to the manufacturing apparatus of the seventh embodiment as described above, similarly to the manufacturing apparatus 1 according to the first embodiment as described above, it is possible to manufacture the optical element O having an accurate thickness and stabilize the outer diameter of the optical element O. Further, the manufacturing apparatus according to the seventh embodiment is able to more rapidly and easily calculate the target thickness T of the optical element O as compared to the other embodiments.

While the embodiments of the manufacturing apparatus for optical element and the manufacturing method for optical element according to the present disclosure are described in detail above, the scope of the present disclosure is not limited by the embodiments described herein, and can be widely interpreted based on the description in the appended claims. Further, various changes, modifications, and the like based on the disclosure are of course included in the scope of the present disclosure.

For example, while the examples have been described in the first to the seventh embodiments in which the optical element O is a convex lens, it is possible to calculate the target thickness T of the optical element O using the same method even when the optical element O is a concave lens.

Additional advantages and modifications will readily occur to those skilled in the art. Therefore, the disclosure in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A manufacturing apparatus for manufacturing an optical element including two spherical segments and a cylindrical portion by performing press molding using a mold on a molding material that is softened by heat, the manufacturing apparatus comprising:
a sensor configured to measure one of a diameter and mass of the molding material;
a calculator configured to calculate a target thickness of the optical element based on one of the diameter and the mass of the molding material measured by the sensor; and
a controller configured to control an inter-mold distance of the mold at a time of press molding such that a thickness of the optical element becomes the target thickness calculated by the calculator unit.

2. The manufacturing apparatus according to claim 1, wherein the calculator calculates the target thickness of the optical element by:
calculating a volume of the molding material based on one of the diameter and the mass of the molding material measured by the sensor; and
calculating heights of the spherical segments and the cylindrical portion of the optical element based on the volume of the molding material, a target outer diameter of the optical element set in advance, and curvatures of the spherical elements of the optical element set in advance.

3. The manufacturing apparatus according to claim 2, wherein the calculator calculates the target thickness of the optical element by:
calculating the heights of the spherical segments of the optical element based on the target outer diameter of the optical element and the curvatures of the spherical segments of the optical element;
calculating volumes of the spherical segments of the optical element based on the heights of the spherical segments of the optical element and the curvatures of the spherical segments of the optical element;
calculating a volume of the cylindrical portion of the optical element by subtracting the volumes of the spherical segments of the optical element from the volume of the molding material;
calculating the height of the cylindrical portion of the optical element based on the volume of the cylindrical portion and the target outer diameter of the optical element; and
adding the heights of the spherical segments of the optical element and the height of the cylindrical portion of the optical element.

4. The manufacturing apparatus according to claim 1, wherein
the sensor measures the mass of the molding material, and
the calculator calculates a volume of the molding material based on the mass of the molding material measured by the sensor and density of the molding material set in advance.

5. The manufacturing apparatus according to claim 1, wherein the calculator calculates the target thickness of the optical element from one of the diameter and the mass of the molding material measured by the sensor by using a relational expression between one of the diameter and the mass of the molding material obtained before molding and the thickness of the optical element obtained after molding, the relational expression being formed in advance.

6. A method of manufacturing an optical element including two spherical segments and a cylindrical portion by performing press molding using a mold on a molding material that is softened by heat, the method comprising:
measuring one of a diameter and mass of the molding material;
calculating a target thickness of the optical element based on one of the diameter and the mass of the molding material; and
controlling an inter-mold distance of the mold at a time of press molding such that a thickness of the optical element becomes the target thickness.

7. The method according to claim 6, wherein the calculating calculates the target thickness of the optical element by
calculating a volume of the molding material based on one of the diameter and the mass of the molding material, and
calculating heights of the spherical segments and the cylindrical portion of the optical element based on the volume of the molding material, a target outer diameter of the optical element set in advance, and curvatures of the spherical elements of the optical element.

8. The method according to claim 7, wherein the calculating calculates the target thickness of the optical element by
calculating the heights of the spherical segments of the optical element based on the target outer diameter of the optical element and the curvatures of the spherical segments of the optical element,
calculating volumes of the spherical segments of the optical element based on the heights of the spherical segments of the optical element and the curvatures of the spherical segments of the optical element,
calculating a volume of the cylindrical portion of the optical element by subtracting the volumes of the spherical segments of the optical element from the volume of the molding material,
calculating the height of the cylindrical portion of the optical element based on the volume of the cylindrical portion and the target outer diameter of the optical element, and
adding the heights of the spherical segments of the optical element and the height of the cylindrical portion of the optical element.

9. The method according to claim 6, further comprising:
measuring mass of the molding material, wherein
the calculating calculates a volume of the molding material based on the mass of the molding material and density of the molding material set in advance.

10. The method according to claim 6, wherein the calculating calculates the target thickness of the optical element from one of the diameter and the mass of the molding material by using a relational expression between one of the diameter and the mass of the molding material obtained before molding and the thickness of the optical element obtained after molding, the relational expression being formed in advance.
